(19) United States
(12) Patent Application Publication
(10) Pub. No.: US 2015/0146136 A1
(43) Pub. Date: May 28, 2015

(54) SIDE-LIGHT TYPE BACKLIGHT MODULE

(71) Applicant: HON HAI PRECISION INDUSTRY CO., LTD., New Taipei (TW)

(72) Inventor: SHAO-HAN CHANG, New Taipei (TW)

(21) Appl. No.: 14/509,401

(22) Filed: Oct. 8, 2014

(30) Foreign Application Priority Data
Nov. 28, 2013 (CN) 201310615328.X

(51) Int. Cl. G02F 1/1335

(52) U.S. Cl. CPC G02F 1/133615
USPC 349/65

(57) ABSTRACT

A side-light type backlight module includes a front bezel, an optical film, a light guide plate, a box-shaped back cover, and a light source board. The optical film is positioned on the light guide plate. The back cover is connected to the front bezel, and the light guide plate is positioned in the back cover and integrated with the back cover by insert-molding. The back cover includes a bottom plate and a plurality of side walls perpendicular to the bottom plate, and the inner surfaces of the bottom plate and the plurality of side walls have high reflectivity. The bottom plate of the back cover defines a number of micro indentations.

### FIELD

The subject matter herein generally relates to backlight modules, and particularly to a side-light type backlight module.

### BACKGROUND

Along with the progress of modern video technology, liquid crystal displays (LCD) have been applied in cell phones, laptops, personal computers (PC), personal digital assistants (PDA), and other consumer electronic products. Since the LCD panel of an LCD apparatus itself does not have the function of emitting light, a backlight module is needed to be positioned under the LCD panel to provide the LCD panel with a required light source.

The typical backlight module can be divided into a direct-light type and an edge-light type according to the location of the light source. A conventional edge-type backlight module includes a bezel, a light source, a light guide plate, a diffusion plate, and a plurality of optical films. The edge-type backlight module includes a light source at an edge of a light guide plate. The light from the light source is guided into the interior of the light guide plate to be subjected to total reflection by a reflective sheet or grid spots on a bottom plate of the light guide plate in order to emit from a top surface of the light guide plate to serve as a planar light source of homogenous brightness for the LCD panel display. The optical films are positioned above the light guide plate. The light emitted from the light guide plate must be sufficiently mixed to ensure the luminance uniformity of the backlight when viewed from above the optical films.

### BRIEF DESCRIPTION OF THE DRAWINGS

Implementations of the present technology will now be described, by way of example only, with reference to the attached figures.

FIG. 1 is an exploded, perspective view of an embodiment of a side-light type backlight module.

FIG. 2 is a cross-sectional view of the side-light type backlight module.

FIG. 3 is a perspective view of a back cover of the side-light type backlight module.

FIG. 4 is a light distribution graph of the side-light type backlight module.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a side-light type backlight module.

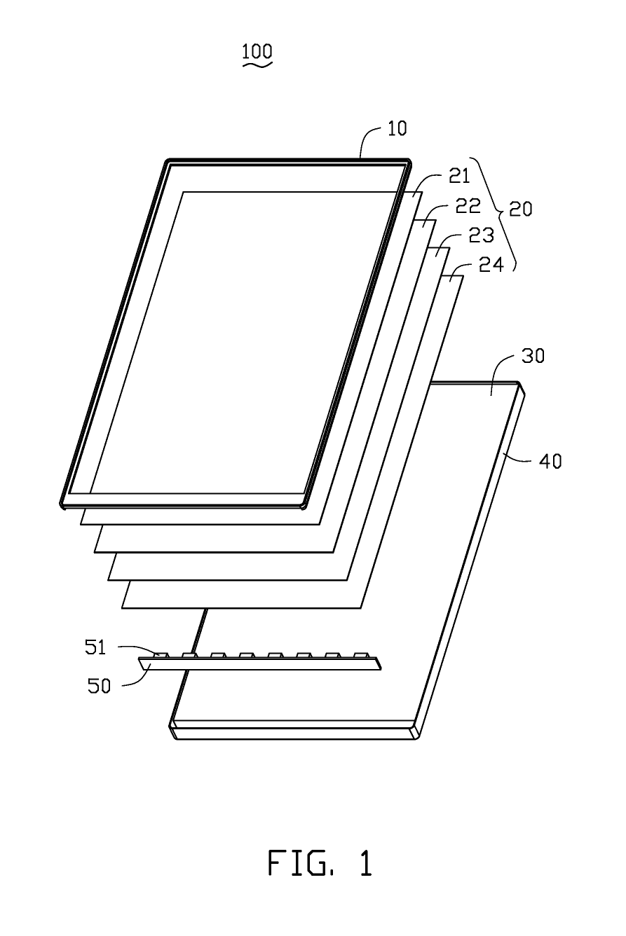

FIG. 1 illustrates an embodiment of a side-light type backlight module 100. The side-light type backlight module 100 can include a front bezel 10, an optical film 20, a light guide plate 30, a back cover 40, and a light source panel 50. The optical film 20 can be assembled to the light guide plate 30, and the back cover 40 can be assembled to the front bezel 10. The front bezel 10 can be a substantially rectangular frame made of plastic. The optical film 20 can include a number of complementary optical elements. In the illustrated embodiment, the optical film 20 can include a first diffusion sheet 21, a first prism lens 22, a second prism lens 23, and a second diffusion sheet 24. The light guide plate 30 can be substantially rectangular and be made of plastic. The light guide plate 30 can be received in the back cover 40. The light source panel 50 can be received in the back cover 40 and be positioned at one side of the light guide plate 30.

The light source panel 50 can be substantially rectangular and include a plurality of light sources 51. The plurality of light sources 51 can be uniformly distributed on a surface of the light source panel 50. In the illustrated embodiment, the light sources 51 can be light emitting diodes (LEDs).

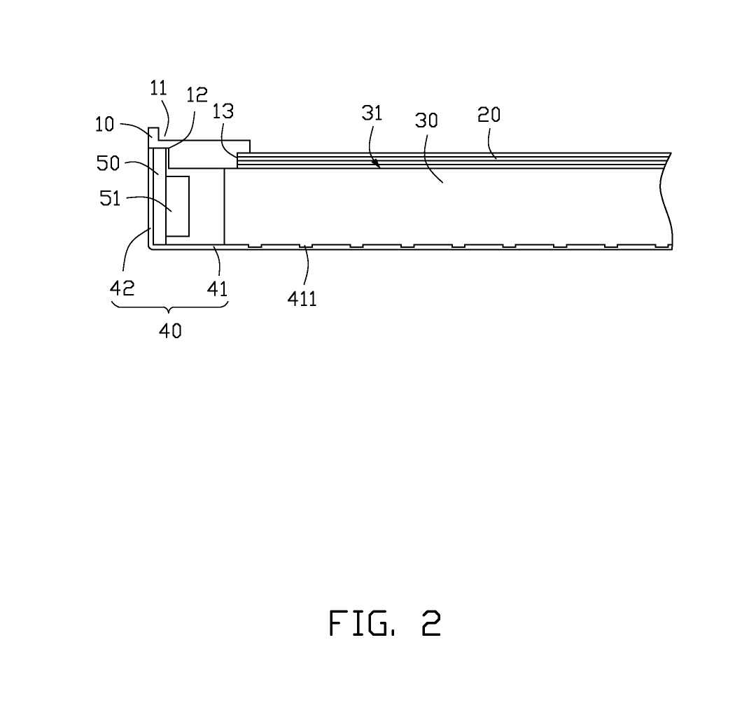

FIG. 2 illustrates that the light source panel 50 can be attached to a sidewall of the back cover 40. The front bezel 10 can define a receiving portion 11 configured to receive the liquid crystal panel (not shown). The receiving portion 11 can be step-shaped. In other embodiments, the receiving portion 11 can be other structures.

The front bezel 10 can define a first groove 12 and a second groove 13. The first groove 12 can partially receive the back cover 40, and the second groove 13 can partially receive the optical film 20.

The light guide plate 30 can include a outer face 31. If an incidence angle of light emitted from the light sources 51 is less than a critical angle of full reflection, the light can be transmitted through the outer face 31. Otherwise, the light can be reflected back into the light guide plate 30. The optical film 20 can be assembled to the outer face 31.

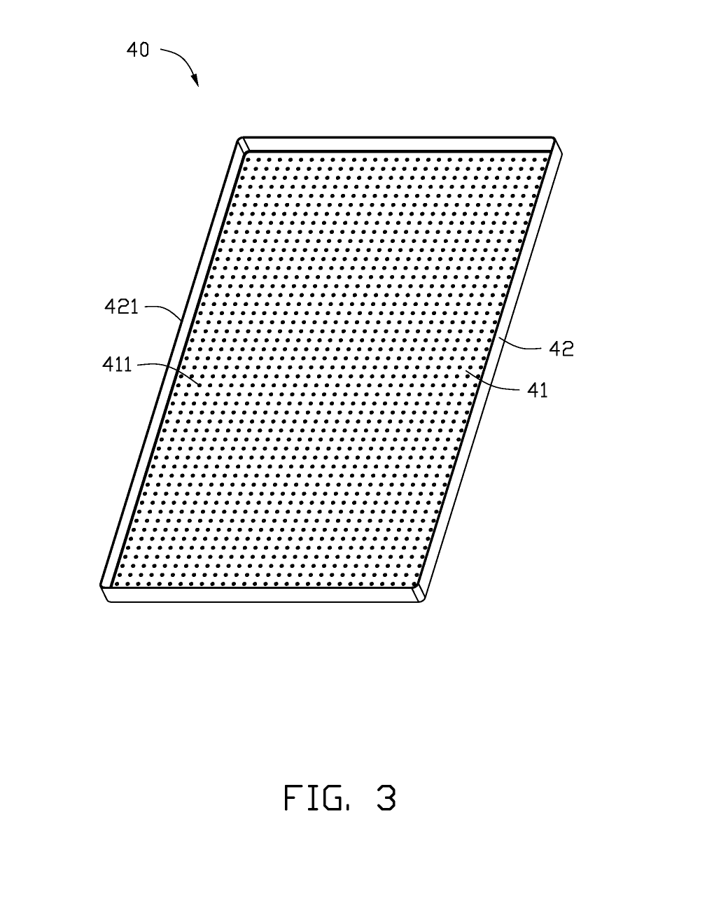

FIG. 3 illustrates that the back cover 40 can be substantially box-shaped and made of a metal. The back cover 40 can include a bottom plate 41 and four side walls 42 substantially perpendicular to the bottom plate 41.

Each of the four side walls 42 can form an upper edge 421 away from the bottom plate 41. The upper edge 421 can be received in the first groove 12 to couple the back cover 40 to the front bezel 10. Inner surfaces of the bottom plate 41 and the four side walls 42 can be covered by a layer having a reflectivity of about 0.9 or greater. The layer can be made of silver or other materials, such as printed ink.

The bottom plate 41 of the back cover 40 can define a plurality of substantially circular micro indentations 411. In other embodiments, each of the plurality of micro indentations 411 can be rectangular or other shapes. Surfaces of the micro indentations 411 can be reflective. The plurality of micro indentations 411 can be uniformly distributed on the back cover 40. The plurality of micro indentations 411 can act as optical dots of the light guide plate 30 to make a luminance of the light emitted from the outer face 31 uniform.

In other embodiments, the plurality of micro indentations 411 can be distributed randomly on the back cover 40

Because the back cover 40 is made of a metal, heat generated from the plurality of light sources 51 can be transferred through the back cover 40 and released, thereby improving the luminance of the plurality of light sources 51. In addition, the back cover 40 can shield the backlight module 100 from electromagnetism.

In at least one embodiment, the light guide plate 30 can be integrated with the back cover 40 by insert molding, to enhance structural integrity of the side-light type backlight module 100. The light guide plate 30 can be integrated with the back cover 40. The side-light type backlight module 100 has less elements than conventional backlight modules, so assembly of the side-light type backlight module 100 is simplified.

In assembly, the light guide plate 30 can be integrated with the back cover 40, and the light source panel 50 can be attached to the sidewall of the back cover 40. The first diffusion sheet 21, the first prism lens 22, the second prism lens 23, and the second diffusion sheet 24 can be stacked together in order. The optical film 20 can be positioned on the outer face 31 of the light guide plate 30. Then, the front bezel 10 can be positioned on the optical film 20. The optical film 20 can be partially received in the second groove 13, and the upper edge 421 can be received in the first groove 12.

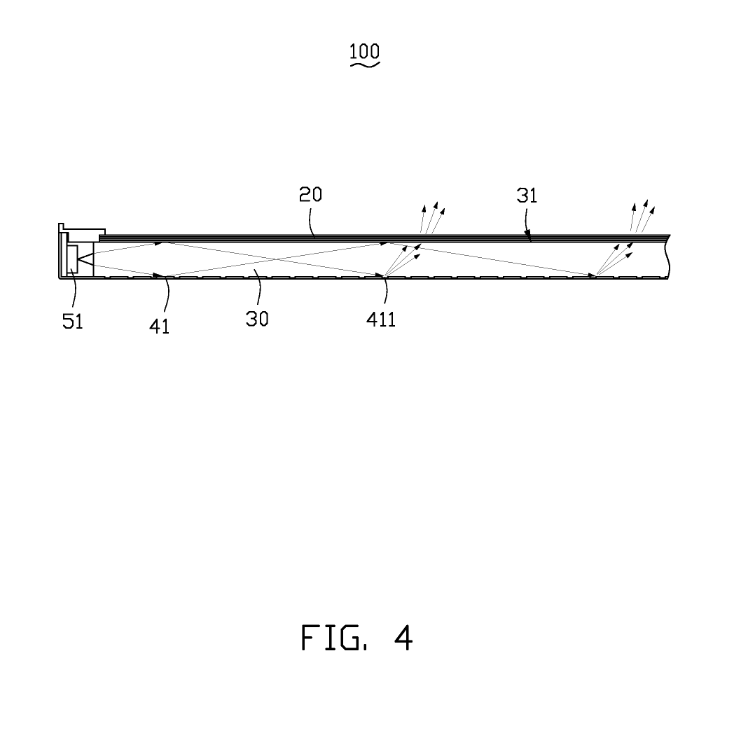

FIG. 4 illustrates a light distribution graph of the side-light type backlight module 100. In use, the plurality of light sources 51 can emit light, and the light can be transmitted into the light guide plate 30. A portion of the light can be transmitted through the outer face 31 of the light guide plate 30 directly. Another portion of the light can be irradiated on the bottom plate 41 of the back cover 40, and scattered by the plurality of micro indentations 411. Thus, the light can be more uniform and be transmitted through the outer face 31 to form small beams of light with high density. As a result, the light incident to the optical film 20 can be more uniform.

As described above, the bottom plate 41 of the back cover 40 can define a plurality of micro indentations 411. The plurality of micro indentations 411 can form optical dots. The light incident to the optical film 20 can be more uniform than in the conventional backlight module. The interior surface of the back cover 40 can be highly reflective, so the light emitted by the side-light type backlight module 100 can have a high utilization. As the light guide plate 30 and the back cover 40 can cooperatively define a receiving portion 11 configured to receive the liquid crystal display panel (not shown), the side-light type backlight module 100 can be thinner than the conventional backlight module.

The embodiments shown and described above are only examples. Many details are often found in the art such as the other features of a side-light type backlight module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A side-light type backlight module comprising:
a back cover having a bottom plate and a plurality of side walls extending substantially perpendicular to the bottom plate from the edges of the bottom plate to form a back cover cavity;
a light guide plate having an inner face and an outer face opposite to and substantially parallel to the inner face, the light guide plate positioned in the back cover cavity with the inner face toward the bottom plate;
a light source panel positioned in the back cover cavity;
an optical film positioned over the outer face of the light guide plate; and
a front bezel attached to the back cover and the optical film;
wherein, the bottom plate and each of the plurality of side walls have an inner surface facing the back cover cavity and the inner surfaces of the bottom plate and each of the side walls have high reflectivity; and
wherein, the inner surface of the bottom plate of the back cover includes a plurality of micro indentations.

2. The side-light type backlight module as claimed in claim 1, wherein the plurality of micro indentations are uniformly distributed on the bottom plate, and each of the plurality of micro indentations is rectangular.

3. The side-light type backlight module as claimed in claim 1, wherein the back cover is made of a metal.

4. The side-light type backlight module as claimed in claim 1, wherein the plurality of the micro indentations are distributed randomly on the bottom plate.

5. The side-light type backlight module as claimed in claim 1, wherein the front bezel defines a first groove and a second groove, the first groove partially receives the plurality of side walls, and the second groove partially receives the optical film.

6. The side-light type backlight module as claimed in claim 1, wherein the front bezel defines a receiving portion, and the receiving portion is step-shaped.

7. The side-light type backlight module as claimed in claim 1, wherein the light source panel is attached to at least one of the side walls.

8. The side-light type backlight module as claimed in claim 1, wherein the light source panel comprises a plurality of light sources, the plurality of light sources are uniformly distributed on a surface of the light source panel.

9. The side-light type backlight module as claimed in claim 8, wherein the light sources are light emitting diodes.

10. The side-light type backlight module as claimed in claim 1, wherein the optical film comprises a first diffusion sheet, a first prism lens, a second prism lens, and a second diffusion sheet arranged on top of each other in that order.
